(19) United States
(12) Patent Application Publication
(10) Pub. No.: US 2012/0030077 A1
(43) Pub. Date: Feb. 2, 2012

(54) DISTRIBUTIVE CORRELATION OF CHARGING RECORDS ACROSS NETWORK DOMAINS

(76) Inventors: Ke Pei, Beijing (CN); Ranjan Sharma, New Albany, OH (US)

(21) Appl. No.: 13/260,436

(22) PCT Filed: Apr. 10, 2009
(86) PCT No.: PCT/US09/40197

§ 371 Date: Sep. 26, 2011

(51) Int. Cl. H04L 12/14; G06Q 30/04

(52) U.S. Cl. 705/34; 705/30

(57) ABSTRACT

Charging systems and associated methods are disclosed that provide correlation across network domains. The charging system includes a plurality of charging functions connected to one or both of an IMS domain and a packet bearer domain, such as a GPRS domain. A first one of the charging functions identifies the charging records for a particular session in the IMS domain based on a charging identifier. The first charging function then selects one of the charging functions on a per-session basis as a correlation charging function for the session, and forwards the identified charging records for the session in the IMS domain to the correlation charging function. A second one of the charging functions selects one of the charging functions on a per-session basis as the correlation charging function for the session, and also forwards charging records for the session in the packet bearer domain to the correlation charging function.

### BACKGROUND

1. Field of the Invention

The invention is related to the field of communications and, in particular, to correlating charging records across network domains.

2. Statement of the Problem

One type of communication network gaining popularity is an IP Multimedia Subsystem (IMS) network. As set forth in the 3^{rd} Generation Partnership Project (3GPP), IMS provides a common core network having a network architecture that allows for various types of access networks. The access network between a communication device and the IMS network may be a cellular network (e.g., CDMA or GSM), a WLAN (e.g., WiFi or WiMAX), an Ethernet network, or another type of wireless or wireline access network. The IMS architecture is initially defined by the 3GPP to provide multimedia services to communication devices over an Internet Protocol (IP) network, as IP networks have become the most cost savings bearer network to transmit video, voice, and data. Service providers are accepting this architecture in next generation network evolution.

To provide offline charging for a session in an IMS network, network elements in the IMS network, such as a Call Session Control Function (S-CSCF, P-CSCF, or I-CSCF), an application server (AS), a Media Gateway Control Function (MGCF), etc, generate Diameter Accounting Request (ACR) messages for the session. When first being involved in the session, the network elements generate ACR[Start] messages. For example, if an S-CSCF receives a SIP INVITE to initiate the session, then the S-CSCF generates an ACR[Start] message. The network elements then transmit the ACR[Start] messages to a Charging Data Function (CDF) that assists in offline charging.

After the session is established, the network elements periodically transmit ACR[Interim] messages to the CDF. The network elements transmit the ACR[Interim] messages to the CDF according to a pre-defined interval, such as every five minutes, or upon a change in the service or media. The service or media change can occur at any time in the session, in contrast to the periodic “heartbeat” mechanism driven by a timer set at a pre-defined interval. If the network elements detect that the session ends, such as by receiving a SIP BYE message, then the network elements generate ACR[Stop] messages. The network elements then transmit the ACR[Stop] messages to the CDF.

When the CDF first receives the ACR[Start] message from a network element, the CDF opens a Charging Data Record (CDR) for the session for that network element. The CDF then updates the open CDR each time it receives an ACR[Interim] message from the network element based on the charging information in the ACR[Interim]. If the CDF receives an ACR[Stop] message from the network element, then the CDF closes the CDR for the session for that network element.

There may be instances where the CDF generates an incomplete CDR for a network element. When the CDF first receives the ACR[Start] message from a network element, the CDF sets a timer. If the CDF receives an ACR[Stop] message from the network element before expiration of the timer, then the CDF closes the CDR for the session to generate a full CDR. If the CDF does not receive an ACR[Stop] message from the network element before expiration of the timer, then the CDF closes the CDR to generate an incomplete CDR for the session. This is an instance of timer-driven incomplete CDR generation. The CDF then opens a new CDR for the session. The CDF will continue to generate incomplete CDRs, driven by the timer, until an ACR[Stop] message is received from the network element. The incomplete CDRs generated upon receipt of an ACR[Interim] message usually do not result in any significant change in the AVPs (Attribute-Value pairs) that are conveyed via the ACR message. Also, if the CDF receives an ACR[Interim] that indicates a service or media change for the session, then the CDF closes the CDR to generate an incomplete CDR for the session.

At some point at the end of the session, the CDRs for the session are aggregated and correlated to be presented to a billing system. Aggregation refers to the operation performed to identify the incomplete CDRs for a network element for a session, and group the incomplete CDRs together. Correlation refers to the operation performed to identify the full and incomplete CDRs for each network element that served the session, and to combine the CDRs to generate a consolidated CDR. The 3GPP presently defines that the trigger for aggregation and correlation is the receipt of an ACR[Stop] message from the S-CSCF. Thus, in response to receiving the ACR[Stop] message from the S-CSCF, the CDF aggregates the incomplete CDRs for each network element (if any). The CDF then transmits the aggregated CDRs and the full CDRs for all of the network elements to a correlation host for the purposes of correlation. The correlation host identifies the CDRs that have emanated for a given session, tied via the IMS Charging Identifier (ICID), and generates a consolidated CDR for the session. The consolidated CDR thus includes the charging information for each of the network elements that served the session in the IMS network. The consolidated CDR is transmitted to a Charging Gateway Function (CGF), which provides persistent storage for the consolidated CDR and then transmits the consolidated CDR to the billing system, which provides billing for the session. The billing system thus receives a single consolidated CDR from the CGF. In practice, the CDF and CGF can be two different elements, or the same physical element providing the services. Together, the CDF and CGF are referred to as a Charging Collection Function (CCF).

The IMS network is considered a signaling domain for a session, as the IMS network is the core network for setting up and maintaining the session. A bearer domain may also be involved in the session. For example, for an IMS voice call, the access network for the voice call may be a General Packet Radio Service (GPRS) network, a Universal Mobile Telecommunications System (UMTS) network, etc. The signaling portion of the call is handled over the IMS network, and the bearer portion may be set up as a Real Time Protocol (RTP) session over the GPRS network. The IMS network may be able to charge for a typical RTP session that is time-based, but there are other instances where it is desirable to acquire charging information from the bearer network as well as the signaling network. For example, during the voice call, a party to the call may download a video over GPRS network. It may be desirable to charge for the data flow of the video download in addition to the time of the session. Thus, there may be multiple domains providing accounting messages to the CDF, not just the IMS domain, which results in charging records from different network domains.

A problem arises when the CCF attempts to correlate the CDRs or other charging records for different network domains. During a typical correlation operation, the CCF correlates the CDRs based on the ICID for the session. Unfortunately, some network domains may not have the ICID for the session as defined in the IMS domain, and cannot include the ICID in any generated CDRs. Thus, the CCF is not able to effectively and efficiently correlate the CDRs for different network domains. A second problem arises when a correlation host is limited by the system throughput. Typically, the CCF includes a commercially available server running a commercially available database to perform aggregation and correlation. Such systems have a limit of a few hundreds to a few thousand Read/Write operations per second, depending on the mix of DB Read and DB Write operations.

### SUMMARY

Embodiments described herein are able to correlate charging records generated for different network domains, such as an IMS domain and a packet bearer domain. A charging system in the embodiments includes a plurality of charging functions. One of the charging functions generates charging records for the IMS domain. The charging records for a particular session are identified and grouped together, and one of the available charging functions is selected to act as the correlation charging function (or correlation host) for the session. The charging records for the IMS domain are then sent to the selected correlation charging function. The same or another one of the charging functions generates charging records for the packet bearer domain. The charging records for the session are identified and grouped together, and the same one of the charging functions is selected to act as the correlation charging function. The charging records for the packet bearer domain are then sent to the selected correlation charging function. The selected correlation charging function may then correlate the charging records from the different network domains.

The correlation charging function is selected based on some session-specific information. Thus, each of the charging functions of the charging system is able to select the same correlation charging function by having the session-specific information. Also, the correlation charging function is selected on a per-session basis. Thus, the correlation duties are distributed among the available charging functions, which advantageously balances the loads on the charging functions and circumvents the per-server throughput limit imposed on the overall solution.

In one embodiment, a charging system is operable to correlate charging records from different network domains. The charging system includes a plurality of charging functions connected to one or both of an IMS domain and a packet bearer domain, such as a GPRS domain. A first one of the charging functions is operable to receive accounting messages from the IMS domain, and to generate charging records for the IMS domain based on the accounting messages. The first charging function is further operable to identify the charging records for a particular session in the IMS domain based on a charging identifier assigned in the IMS domain to the session. The first charging function is further operable to select one of the charging functions on a per-session basis as a correlation charging function for the session, and to transmit the identified charging records for the session in the IMS domain to the correlation charging function. For example, the first charging function may use a distributing function (e.g., a MOD function) and some session-specific information to select the correlation charging function. Thus, each of the charging functions identifies the same correlation charging function for the session.

A second one of the charging functions is operable to receive accounting messages for the session from the packet bearer domain, to generate a charging record for the packet bearer domain based on the accounting messages. The second charging function is further operable to select one of the charging functions on a per-session basis as the correlation charging function for the session, and to transmit the charging record for the session in the packet bearer domain to the correlation charging function.

Other exemplary embodiments may be described below.

### DESCRIPTION OF THE DRAWINGS

Some embodiments of the present invention are now described, by way of example only, and with reference to the accompanying drawings. The same reference number represents the same element or the same type of element on all drawings.

FIG. 1 illustrates a communication network in an exemplary embodiment.

FIG. 2 is a flow chart illustrating a method of correlating charging records across network domains in an exemplary embodiment.

FIGS. 3-4 are flow charts illustrating the selection of a correlation charging function based on a distributing function in exemplary embodiments.

FIG. 5 is a flow chart illustrating a method of correlating charging records across network domains in an exemplary embodiment.

FIG. 6 illustrates another communication network in an exemplary embodiment.

### DESCRIPTION OF EMBODIMENTS

The figures and the following description illustrate specific exemplary embodiments of the invention. It will thus be appreciated that those skilled in the art will be able to devise various arrangements that, although not explicitly described or shown herein, embody the principles of the invention and are included within the scope of the invention. Furthermore, any examples described herein are intended aid in understanding the principles of the invention, and are to be construed as being without limitation to such specifically recited examples and conditions. As a result, the invention is not limited to the specific embodiments or examples described below, but by the claims and their equivalents.

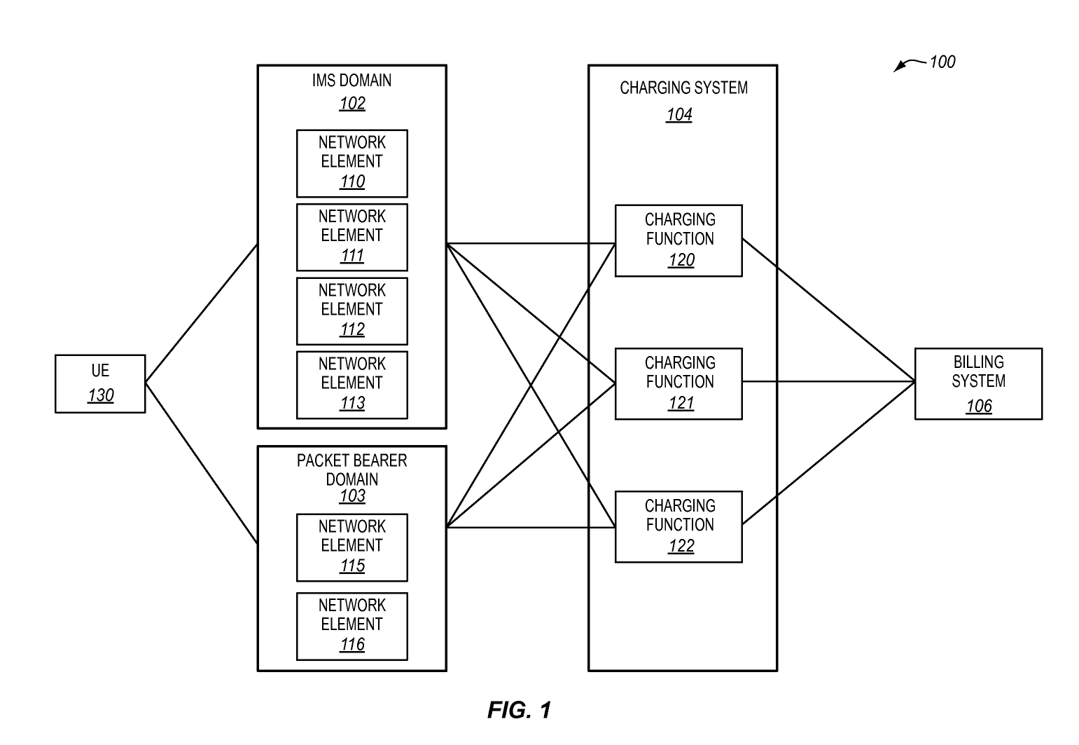

FIG. 1 illustrates a communication network 100 in an exemplary embodiment. Communication network 100 includes an IMS domain 102, a packet bearer domain 103, a charging system 104, and a billing system 106. IMS domain 102 (also referred to as an IMS network) includes a plurality of network elements 110-113. Network elements 110-113 comprise any systems, servers, or functions operable to serve a session or provide a service for a session (also referred to as a call) within IMS domain 102. For example, network element 110 may comprise a Serving-Call Session Control Function (S-CSCF), network element 111 may comprise an Interrogating-Call Session Control Function (I-CSCF), network element 112 may comprise a Media Gateway Control Function (MGCF), and network element 113 may comprise an application server (AS). Although four network elements 110-113 are shown, those skilled in the art will appreciate that IMS domain 102 may include more or less network elements.

Packet bearer domain 103 comprises any network that is operable to transport bearer packets for sessions. Examples of packet bearer domain 103 include a General Packet Radio Service (GPRS) and a Universal Mobile Telecommunications System (UMTS) network. Packet bearer domain 103 includes a plurality of network elements 115-116. Network elements 115-116 comprise any systems, servers, or functions operable to serve a session or provide a service for a session (also referred to as a call) within packet bearer domain 103. For example, network element 115 may comprise a Gateway GPRS Support Node (GGSN), and network element 116 may comprise a Serving GPRS Support Node (SGSN).

Charging system 104 comprises any system, server, or function operable to receive accounting messages from IMS domain 102 and packet bearer domain 103, and to generate a consolidated Charging Data Record (CDR) for sessions. Charging system 104 includes a plurality of charging functions 120-122. Each of charging functions 120-122 may comprise a Charging Data Function (CDF)/Charging Gateway Function (CGF) as defined by the 3GPP in Release 6, a Charging Collection Function (CCF) as defined by the 3GPP in Release 5, or some other system that is able to perform charging.

Billing system 106 comprises any system, server, or function operable to receive a consolidated CDR for a session, and to bill a customer for the session based on the consolidated CDR. Communication network 100 may include other networks, systems, or devices not shown in FIG. 1, such as additional network elements, additional charging functions, etc.

Any of the various elements shown in the figures or described herein may be implemented as hardware, software, firmware, or some combination of these. For example, an element may be implemented as dedicated hardware. Dedicated hardware elements may be referred to as “processors”, “controllers”, or some similar terminology. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, a network processor, application specific integrated circuit (ASIC) or other circuitry, field programmable gate array (FPGA), read only memory (ROM) for storing software, random access memory (RAM), non volatile storage, logic, or some other physical hardware component or module.

Also, an element may be implemented as instructions executable by a processor or a computer to perform the functions of the element. Some examples of instructions are software, program code, and firmware. The instructions are operational when executed by the processor to direct the processor to perform the functions of the element. The instructions may be stored on storage devices that are readable by the processor. Some examples of the storage devices are digital or solid-state memories, magnetic storage media such as a magnetic disks and magnetic tapes, hard drives, or optically readable digital data storage media.

Assume for this embodiment that one or more of network elements 110-113 serves a session involving user equipment (UE) 130. Further assume that each network element 110-113 includes a Charging Trigger Function (CTF) that generates accounting messages while serving the session. An accounting message comprises any charging message that includes information used to bill for a session. For instance, at the beginning of the session, a network element 110 may generate an initial accounting message, and transmit the initial accounting message to charging system 104. One example of an initial accounting message is a Diameter ACR[Start] message. During the session, network element 110 may periodically generate interim accounting messages based on a predefined timer, and transmit the interim accounting messages to charging system 104. One example of an interim accounting message is a Diameter ACR[Interim] message. At the end of the session, network element 110 may generate a stop accounting message, and transmit the stop accounting message to charging system 104. One example of a stop accounting message is a Diameter ACR[Stop] message. Network elements 115-116 in packet bearer domain 103 may include similar CTFs in order to provide accounting messages to charging system 104, although network elements 115-116 may use a different reference point (e.g., other than Diameter) when communicating with charging system 104.

The following embodiments illustrate how charging system 104 operates to perform charging for a session across multiple network domains. More particularly, when a session extends over IMS domain 102 and packet bearer domain 103, charging system 104 is able to correlate charging records for both IMS domain 102 and packet bearer domain 103 to generate a consolidated CDR for the session.

Assume for this embodiment that one or more of network elements 110-113 in IMS domain 102 serves a session involving UE 130. Network elements 110-113 may serve other sessions as well for other UE's not shown in FIG. 1. While serving the session in IMS domain 102, network elements 110-113 trigger on charging events to generate accounting messages, and transmit the accounting messages to charging system 104. In this embodiment, network elements 110-113 transmit accounting messages to charging function 120. Further assume that one or more of network elements 115-116 in packet bearer domain 103 serves the session involving UE 130. While serving the session in packet bearer domain 103, network elements 115-116 trigger on charging events to generate accounting messages, and transmit the accounting messages to charging system 104. In this embodiment, network elements 115-116 transmit accounting messages to charging function 121.

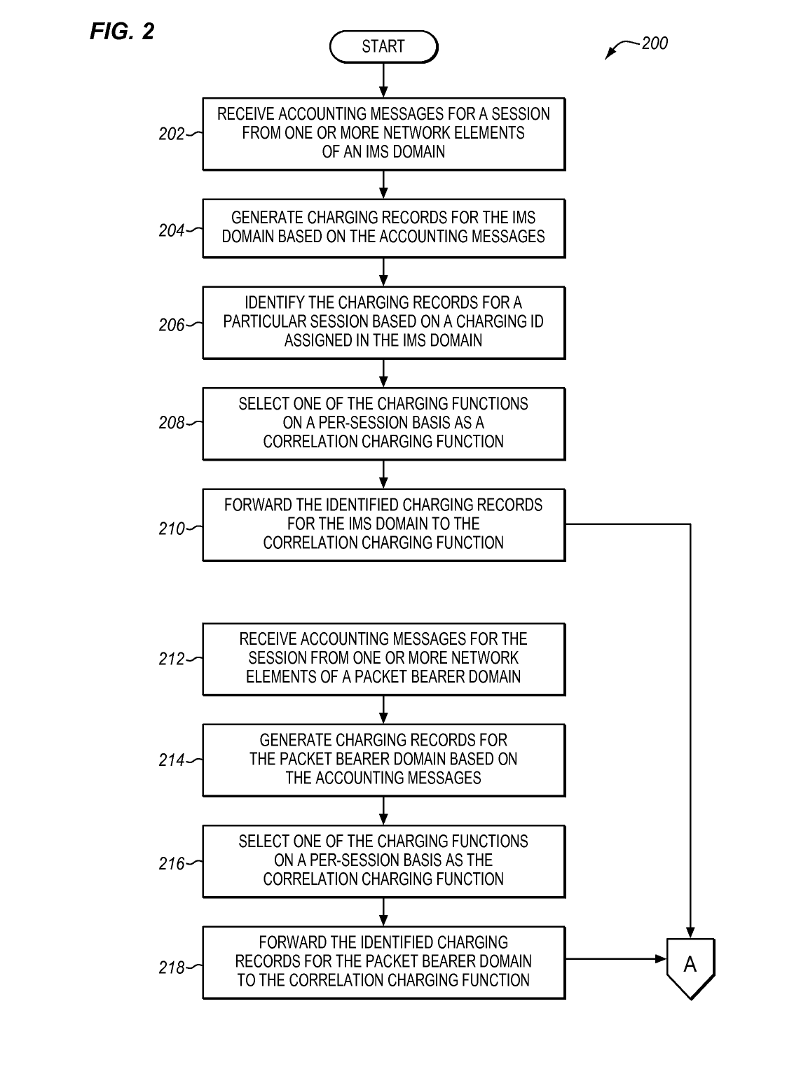

FIG. 2 is a flow chart illustrating a method 200 of providing charging records to a correlation charging function in an exemplary embodiment. The steps of method 200 will be described with reference to communication network 100 in FIG. 1, but those skilled in the art will appreciate that method 200 may be performed in other networks. Also, the steps of the flow chart in FIG. 2 are not all inclusive and may include other steps not shown, and the steps may be performed in an alternative order.

In step 202, charging function 120 receives accounting messages for the session involving UE 130 from one or more of network elements 110-113 in IMS domain 102. Charging function 120 may also receive accounting messages for other sessions in the IMS domain 102. In step 204, charging function 120 generates charging records for IMS domain 102 based on the accounting messages. A charging record for IMS domain 102 comprises some record or data structure that includes information on a session that is used for charging, such as a Charging Data Record (CDR). A CDR generated by charging function 120 may comprise a full CDR or an incomplete CDR.

To initiate correlation of charging records for a particular session, charging function 120 identifies the charging records for the session in IMS domain 102 based on a charging identifier assigned in IMS domain 102 to the session, in step 206. In other words, charging function 120 filters the charging records for IMS domain 102 based on the charging identifier to identify the charging records for this session. In this embodiment, charging function 120 identifies the charging records for a particular session involving UE 130. When the session involving UE 130 is initiated within IMS domain 102, a network element 110-113 assigns the charging identifier to the session. In a typical example, a P-CSCF in IMS domain 102 assigns an IMS Charging Identifier (ICID) to the session, which is subsequently included in the charging records for the session. The ICID may thus be used to identify the charging records that pertain to a particular session. After identifying the charging records for a session, charging function 120 may correlate the charging records for the IMS domain 102, or otherwise group the records together. Correlating in this manner is referred to as intra-domain correlation, which generates a consolidated charging record for IMS domain 102.

Charging function 120 also determines where to forward the IMS domain charging records that have been identified for the session. Thus, charging function 120 selects one of the charging functions 120-122 on a per-session basis as a correlation charging function in step 208. Charging function 120 is able to select the correlation charging function on a per-session basis through session-specific information so that the same one of the charging functions 120-122 is not used as the dedicated correlation charging function for all sessions. In one embodiment, charging function 120 may use a distributing function and the session-specific information to select the correlation charging function. A distributing function comprises an algorithm or mathematical function configured to distribute or allocate the duties of charging record correlation among charging functions 120-122 for different sessions. The correlation charging function is selected based on the distributing function from the available charging functions 120-122 in charging system 104. By selecting the correlation charging function based on the distributing function, the duties of correlation for different sessions is distributed among the charging functions 120-122 to balance the loads handled by each of the charging functions 120-122.

In step 210, charging function 120 forwards the identified charging records for the session in IMS domain 102 to the correlation charging function. Those skilled in the art will appreciate that if charging function 120 is selected as the correlation charging function, then step 210 is not needed as charging function 120 already stores the identified charging records.

In step 212, charging function 121 receives accounting messages from packet bearer domain 103. In step 214, charging function 121 generates charging records for packet bearer domain 103 based on the accounting messages. A charging record for packet bearer domain 103 also comprises some record or data structure that includes information on a session that is used for charging, such as CDRs, Usage Detail Records (UDR), Flow Detail Records (FDR), etc. As described above for IMS domain 102, charging function 121 may identify the charging records for a particular session in packet bearer domain 103 based on a charging identifier assigned in packet bearer domain 103 to the session. For example, network element in packet bearer domain 103 may assign an Access Network Charging Identifier (ANCID) to the session, which is subsequently included in the charging records for the session. The ANCID may thus be used to identify the charging records that pertain to a particular session. After identifying the charging records for a session, charging function 121 may correlate the charging records for packet bearer domain 103, or otherwise group the records together. Correlating in this manner is again referred to as intra-domain correlation, which generates a consolidated charging record for packet bearer domain 103.

In step 216, charging function 121 selects one of the charging functions 120-122 on a per-session basis as a correlation charging function for the session. Charging functions 120 and 121 both select the same correlation charging function on the per-session basis. For example, charging functions 120 and 121 may use the same distributing function to select the same correlation charging function for the session. Thus, each of the charging records generated for the session will be sent to the same correlation charging function regardless of whether the charging record is for IMS domain 102 or packet bearer domain 103. In step 218, charging function 121 forwards the charging record for the session in packet bearer domain 103 to the correlation charging function. Those skilled in the art will appreciate that if charging function 121 is selected as the correlation charging function, then step 218 is not needed as charging function 121 already stores the charging record.

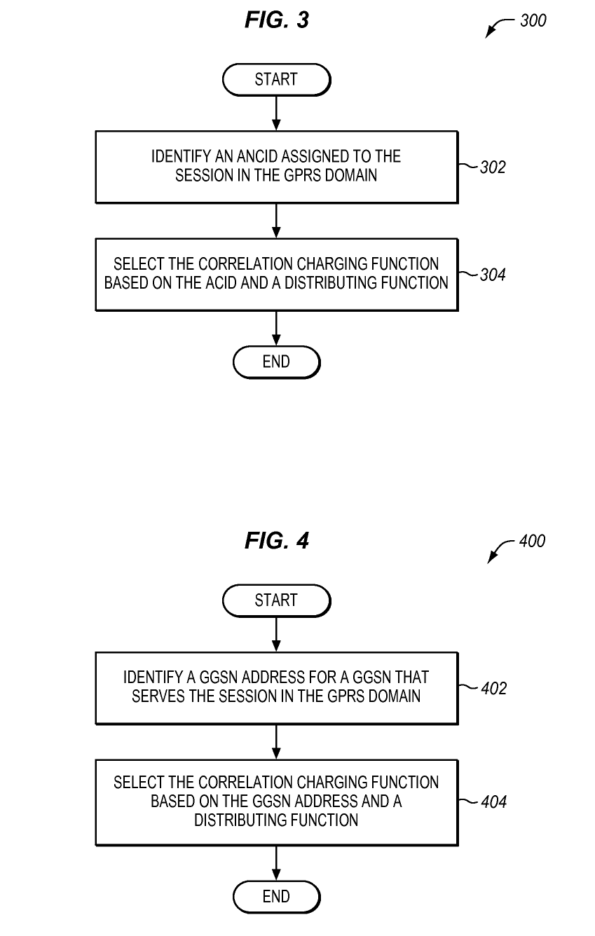

If packet bearer domain 103 comprises a GPRS domain, then the correlation charging function may be selected in the following manner. FIGS. 3-4 are flow charts illustrating the selection of a correlation charging function based on a distributing function in exemplary embodiments. In FIG. 3, charging system 120 or 121 identifies an Access Network Charging Identifier (ANCID) (e.g., a GPRS Charging Identifier (GCID)) assigned to the session in the GPRS domain in step 302. In step 304, charging system 120 or 121 selects the correlation charging function based on the ANCID and a distributing function that distributes the correlation charging function among the plurality of charging functions 120-122 on a per-session basis. One example of a distributing function used in charging functions 120 and 121 comprises a modulo function. A modulo function may be expressed as “a MOD n”. The result of the modulo function is the remainder of the division of a by n. The variables a and n may be assigned in a number of different ways. In one example, the modulo function may be used with all or a portion of an ANCID as the dividend (“a”), and some number as the divisor (“n”). The divisor n may be assigned based on the number of charging functions 120-122 plus 1 for example.

In FIG. 4, charging system 120 or 121 identifies a Gateway GPRS Support Node (GGSN) that serves the session in the GPRS domain in step 402. In step 404, charging system 120 or 121 selects the correlation charging function based on the GGSN address and a distributing function that distributes the correlation charging function among the plurality of charging functions 120-122 on a per-session basis. For example, a modulo function may be used with all or a portion of a GGSN address as the dividend (“a”), and some number as the divisor (“n”). Because charging functions 120 and 121 select the correlation charging function in the same manner, all of the charging records generated for the session are sent to the same correlation charging function.

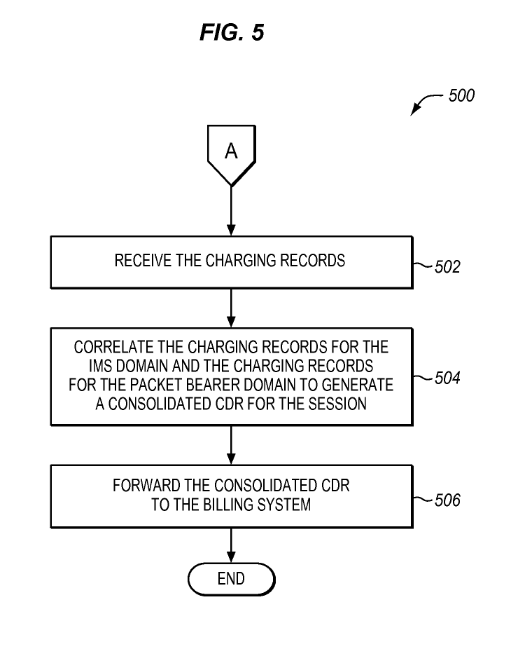

FIG. 5 is a flow chart illustrating a method 500 of correlating charging records across network domains in an exemplary embodiment. The steps of method 500 will be described with reference to communication network 100 in FIG. 1, but those skilled in the art will appreciate that method 500 may be performed in other networks. Also, the steps of the flow chart in FIG. 5 are not all inclusive and may include other steps not shown, and the steps may be performed in an alternative order.

In step 502, the correlation charging function receives the charging records for the session whether they are generated for IMS domain 102 or packet bearer domain 103. The correlation charging function stores the charging records for the session in a local database.

In step 504, the correlation charging function correlates the charging records for IMS domain 102 and the charging record(s) for packet bearer domain 103 to generate a consolidated Charging Data Record (CDR) for the session. Steps 502 and 504 in method 200 may be referred to as “correlating” the charging records for the session. Correlating in this manner is referred to as inter-domain correlation or cross-domain correlation, which generates a consolidated charging record for both IMS domain 102 and packet bearer domain 103. The trigger for correlation may vary depending on desired implementations. In one embodiment, the correlation charging function may trigger correlation upon receiving a charging record for the Serving-Call Session Control Function (S-CSCF) in IMS domain 102. In step 506, the correlation charging function forwards the consolidated CDR to billing system 106. Based on the consolidated CDR, billing system 106 may resolve a bill for the session that includes charging for both IMS domain 102 and packet bearer domain 103.

In response to the S-CSCF charging record, the correlation charging function identifies the charging identifier (e.g., ICID) assigned in IMS domain 102 in the charging record for the S-CSCF. The correlation charging function then identifies the charging records for IMS domain 102 that include the charging identifier assigned in IMS domain 102. The correlation charging function also identifies one or more charging identifiers (i.e., ANCID) assigned to the session in packet bearer domain 103 that is included in the charging record for the S-CSCF. The correlation charging function identifies the charging records for packet bearer domain 103 that include the charging identifiers assigned in packet bearer domain 103. The correlation charging function then correlates the identified charging records, as shown in step 504, to generate the consolidated CDR.

Being able to correlate charging records in the manner described above provides many advantages. The correlation duties are distributed among the available charging functions 120-122, which balances the loads on the charging functions 120-122. Traditionally, a single centralized charging function was designated with a charging system as the correlation charging function for all sessions. This centralized charging function actually acted as a bottleneck because of the intensive processing needed to correlate all of the charging records for all of the sessions. The distributed approach described above does not burden any one centralized charging function to perform correlation for all sessions. A correlation charging function is assigned on a per-session basis, and the duties of correlation essentially rotate among the available charging functions. This distributed approach allows charging system 104 to operate more efficiently, and raises the overall throughput.

### EXAMPLE 1

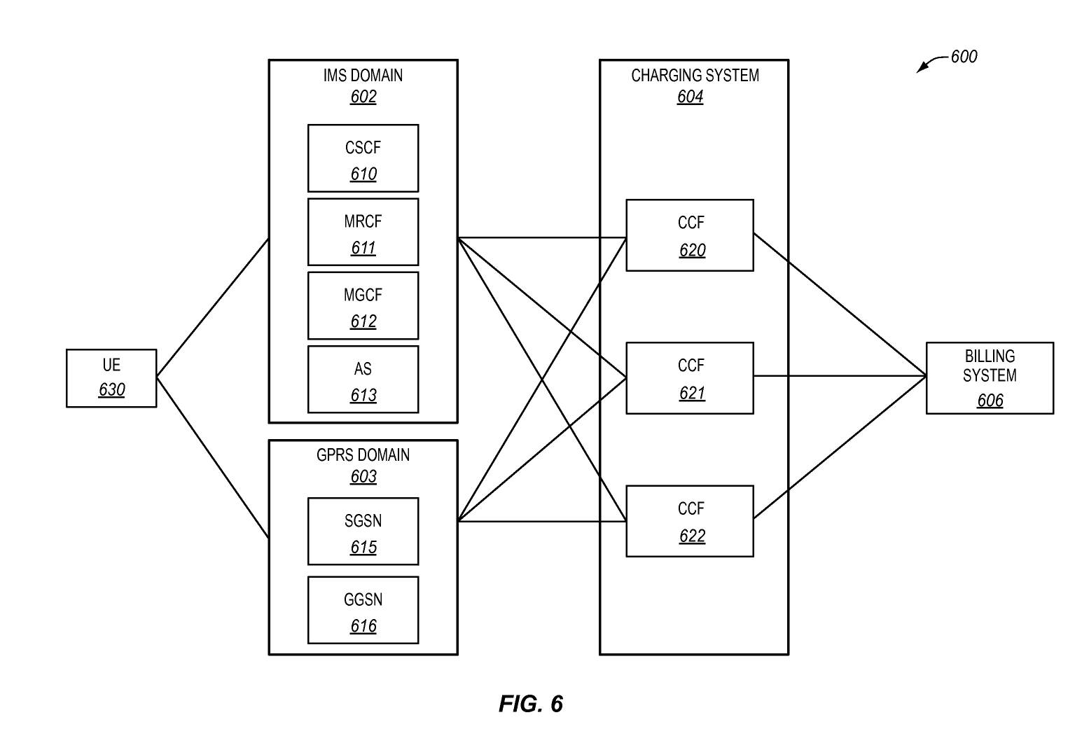

FIG. 6 illustrates another communication network 600 in an exemplary embodiment of the invention. Communication network 600 includes an IMS domain 602 and a GPRS domain 603. IMS domain 602 includes a (P, S, and/or I) CSCF 610, a Media Resource Control Function (MRCF) 611, a Media Gateway Control Function (MGCF) 612, and an application server (AS). IMS domain 602 may include additional network elements in other embodiments. GPRS domain 603 includes SGSN 615 and GGSN 616. GPRS domain 603 may include additional network elements in other embodiments.

Communication network 600 further includes a charging system 604 that connects to a billing system 606. Charging system 604, in this example, includes a plurality of Charging Collection Functions (CCFs) 620-622. Although three CCFs 620-622 are shown, those skilled in the art will appreciate that charging system 604 may have many more CCF's. Each of CCFs 620-622 may include a CDF coupled to a CGF over a Ga interface, which is not shown in FIG. 6 for the sake of brevity. The network elements in IMS domain 602 connect with CCFs 620-622 over a Diameter Rf interface. The network elements in GPRS domain 603 may connect with CCFs 620-622 over a Diameter Rf interface or over a Ga interface.

Assume for this example that UE 630 initiates a session over IMS domain 602 using GPRS domain 603 as the access network. CSCF 610, which includes P-CSCF, I-CSCF, and S-CSCF, serves the session in IMS domain 602. When the P-CSCF first receives a SIP message for the session, the P-CSCF assigns an ICID for the session. The ICID is shared with other network elements in IMS domain 602.

SSGN 615 and GGSN 616 serve the session in GPRS domain 603. When the session is set up in GPRS domain 603, a Packet Data Protocol (PDP) context is set up, which is a data structure set up in SGSN 615 and GGSN 616 that contains the session information. When a PDP context is set up in GGSN 616, GGSN 616 assigns a GCID to the PDP context (the GCID comprises the Access Network Charging Identifier (ANCID)). The GCID is shared with SSGN 615. The GCID is also shared with the S-CSCF and P-CSCF in IMS domain 602, but is not shared with the I-CSCF in IMS domain 602.

The following describes inter-domain correlation for a single PDP context in GPRS domain 603. While IMS domain 602 is setting up or serving the session for UE 630, CSCF 610 and other network elements in IMS domain 602 trigger on charging events for the session, and transmit ACR messages to CCF 620. The ACR messages from the S-CSCF and the P-CSCF include the ICID for the session, and the GCID for the PDP context in GPRS domain 603. The ACR messages from the I-CSCF only include the ICID for the session, and do not include the GCID.

In GPRS domain 603, SGSN 615 triggers on charging events for the session, and transmits ACRs (or accounting messages of another protocol) to CCF 621. Likewise, GGSN 616 triggers on charging events for the session, and transmits ACRs (or accounting messages of another protocol) to CCF 622. The ACR messages from SGSN 615 and GGSN 616 include the GCID for the PDP context, but not the ICID.

In response to the ACR messages, each CCF 620-622 generates one or more charging records based on the ACR messages. For example, CCF 620 generates a CDR for each of the S-CSCF, the P-CSCF, and the I-CSCF, and stores these CDRs in a local database. CCF 621 generates an S-CDR for SGSN 615, and stores the S-CDR in a local database. CCF 622 generates a G-CDR for GGSN 616, and stores the G-CDR in a local database. The following indicates the CDRs stored for this session:

CCF 620—stores CDR for S-CSCF, with ICID=a1, and GCID=b1

CCF 620—stores CDR for P-CSCF, with ICID=a1, and GCID=b1

CCF 620—stores CDR for I-CSCF, with ICID=a1 (no GCID)

CCF 621—stores S-CDR for SGSN, with GCID=b1 (no ICID)

CCF 622—stores G-CDR for GGSN, with GCID=b1 (no ICID)

The following illustrates how CDRs are correlated across network domains. First, CCF 620 filters the CDRs stored in its local database based on the ICID for the session (e.g., ICID=a1), and identifies the CDRs that have the ICID for the session. In this example, there are three CDRs having an ICID=“a1”, which are the CDRs from the S-CSCF, the P-CSCF, and the I-CSCF. After identifying the CDRs for this session, CCF 620 may perform intra-network correlation on the identified CDRs to generate a consolidated CDR for IMS domain 602. The intra-network correlation may be initiated in response to a triggering event, such as receiving an ACR[Stop] from the S-CSCF. However, in practice, the intra-network correlation is eschewed in favor of inter-network (or cross-domain) correlation.

The process of identifying the CDRs for the session based on the ICID, and correlating the CDRs for IMS domain 602 provide advantages. Some prior solutions for correlating CDRs across different network domains suggested using the GGSN address or the GCID for correlation. However, the CDR from the I-CSCF does not include a GCID or a GGSN address. Thus, those prior correlation methods may not be effective. Because the CDRs for IMS domain 602 are correlated or otherwise grouped together by the ICID, the CDR for the I-CSCF will be considered in the inter-network correlation.

After correlating or otherwise grouping together the CDRs for IMS domain 602, CCF 620 determines where to forward the CDRs. Thus, CCF 620 selects a correlation CCF from the plurality of available CCFs 620-622. To select the correlation CCF in this embodiment, CCF 620 first identifies a GCID that was assigned to the session in GPRS domain 603, which is “b1”. The GCID may be identified from a CDR for the S-CSCF, a CDR from the P-CSCF, or from another CDR from another network element (except the I-CSCF). CCF 620 then applies a distributing function using all or part of the GCID to select the correlation CCF. In this example, there are n CCFs available in charging system 604. CCF 620 thus determines the result of the following function: m=b1 MOD (n+1). The correlation CCF will thus be CCF-m (where m equal, 1, 2, 3, 4, etc). CCF 620 then forwards the CDRs for IMS domain 602 to the selected correlation CCF, which is CCF-m.

CCFs 621 and 622 also select the correlation CCF in a similar manner to determine where to forward CDRs for the session that are stored their local databases. Thus, CCF 621 identifies a GCID from the CDR for the SGSN, which is “b1”. CCF 621 then determines the result of the following function: m=b1 MOD (n+1). The correlation CCF will again be CCF-m. CCF 621 then forwards the CDR for the SGSN to the selected correlation CCF, which is CCF-m. In a similar manner, CCF 622 identifies a GCID from the CDR for the GGSN, which is “b1”. CCF 622 then determines the result of the following function: m=b1 MOD (n+1). The correlation CCF will again be CCF-m. CCF 622 then forwards the CDR for the GGSN to the selected correlation CCF, which is CCF-m.

The correlation CCF (CCF-m) will receive all of the CDRs for the session from each network domain based on the MOD function, and store the CDRs in its local database. The correlation CCF is thus tasked with the duties of correlating the CDRs for this session. Correlation then begins responsive to a correlation trigger, such as a receiving a full CDR for the S-CSCF in the IMS domain 602. The correlation CCF identifies the ICID in the S-CSCF CDR, and gathers the other CDRs stored in its local database that share this ICID. The correlation CCF also identifies the GCID in the S-CSCF CDR, and gathers the other CDRs stored in its local database that share this GCID. After gathering all of the CDRs for the session based on the ICID and the GCID, the correlation CCF follows a correlation template whereby designated fields from the CDRs are extracted and the template is filled out. This results in a consolidated CDR for the session that includes session-related CDR information and packet bearer-related CDR information. The correlation CCF then forwards the consolidated CDR for the session to billing system 606 via a Bx interface (FTP or secure FTP).

### EXAMPLE 2

In further reference to FIG. 6, the following describes inter-domain correlation for multiple PDP contexts in GPRS domain 603 in an exemplary embodiment of the invention. As in the previous example, CSCF 610 and other network elements in IMS domain 602 trigger on charging events for the session, and transmit ACR messages to CCF 620. In GPRS domain 603, SGSN 615 triggers on charging events for the session, and transmits ACRs (or accounting messages of another protocol) to CCF 621. Likewise, GGSN 616 triggers on charging events for the session, and transmits ACRs (or accounting messages of another protocol) to CCF 622. In this example, there are two PDP contexts established for the session in GPRS domain 603. Thus, there are two GCIDs assigned to the two PDP contexts.

In response to the ACR messages, each CCF 620-622 generates one or more charging records based on the ACR messages. For example, CCF 620 generates a CDR for each of the S-CSCF, the P-CSCF, and the I-CSCF, and stores these CDRs in a local database. CCF 621 generates S-CDRs for SGSN 615, and stores the S-CDRs in a local database. CCF 622 generates G-CDRs for GGSN 616, and stores the G-CDRs in a local database. The following indicates the CDRs stored for this session:

CCF 620—stores CDR for S-CSCF, with ICID=a1, GCID=b1,b2, GGSN addr=g1

CCF 620—stores CDR for P-CSCF, with ICID=a1, GCID=b1,b2, GGSN addr=g1

CCF 620—stores CDR for I-CSCF, with ICID=a1 (no GCIDs or GGSN addr)

CCF 621—stores S-CDR for SGSN, with GCID=b1, GGSN addr=g1 (no ICID)

CCF 621—stores S-CDR for SGSN, with GCID=b2, GGSN addr=g1 (no ICID)

CCF 622—stores G-CDR for GGSN, with GCID=b1, GGSN addr=g1 (no ICID)

CCF 622—stores G-CDR for GGSN, with GCID=b2, GGSN addr=g1 (no ICID)

The following illustrates how CDRs are correlated across network domains. First, CCF 620 filters the CDRs stored in its local database based on the ICID for the session (e.g., ICID=a1), and identifies the CDRs that have the ICID for the session. In this example, there are three CDRs having an ICID=“a1”, which are the CDRs from the S-CSCF, the P-CSCF, and the I-CSCF. After identifying the CDRs for this session, CCF 620 may perform intra-network correlation on the identified CDRs to generate a consolidated CDR for IMS domain 602. However, CCF 620 can also delegate this responsibility to the inter-network correlation host.

After correlating or otherwise grouping together the CDRs for IMS domain 602, CCF 620 determines where to forward the CDRs. Thus, CCF 620 selects a correlation CCF from the plurality of available CCFs 620-622. To select the correlation CCF in this embodiment, CCF 620 first identifies a GGSN address that was assigned to the session in GPRS domain 603, which is “g1”. The GGSN address may be identified from a CDR for the S-CSCF, a CDR from the P-CSCF, or from another CDR from another network element (except the I-CSCF). CCF 620 then applies a distributing function to the GGSN address to select the correlation CCF. In this example, there are n CCFs available in charging system 604. CCF 620 thus determines the result of the following function: m=g1 MOD (n+1). The correlation CCF will thus be CCF-m. CCF 620 then forwards the CDRs for IMS domain 602 to the selected correlation CCF, which is CCF-m.

CCFs 621 and 622 also select the correlation CCF in a similar manner to determine where to forward CDRs for the session that are stored their local databases. Thus, CCF 621 identifies a GGSN address from a CDR for the SGSN, which is “g1”. CCF 621 then determines the result of the following function: m=g1 MOD (n+1). The correlation CCF will again be CCF-m. CCF 621 then forwards the CDRs for the SGSN to the selected correlation CCF, which is CCF-m. In a similar manner, CCF 622 identifies a GGSN address from a CDR for the GGSN, which is “g1”. CCF 622 then determines the result of the following function: m=g1 MOD (n+1). The correlation CCF will again be CCF-m. CCF 622 then forwards the CDRs for the GGSN to the selected correlation CCF, which is CCF-m.

The correlation CCF (CCF-m) will receive all of the CDRs for the session from each network domain based on the MOD function, and store the CDRs in a local database. The correlation CCF will then correlate the CDRs for the session as described in the previous example to generate a consolidated CDR for the session that includes both session-related CDR information and packet bearer-related CDR information. The correlation CCF then forwards the consolidated CDR for the session to billing system 606 via a Bx interface (FTP or secure FTP).

In the first example, the correlation CCF was selected based on a MOD function and a GCID. In the second example, the correlation CCF was selected based on a MOD function and a GGSN address. When determining where to forward the CDRs for a session, the CCF may first determine whether there are multiple PDP contexts defined for the session. In other words, the CCF determines whether there are multiple GCIDs. If there is one PDP context (i.e., one GCID) corresponding to a session (characterized by the ICID), then the CCF may select the correlation CCF based on the GCID. If corresponding to the same session (characterized by the ICID), there are multiple PDP contexts defined (i.e., multiple GCIDs), then the CCF may select the correlation CCF based on the GGSN address. Alternatively, the CCF may select the correlation CCF based on the GGSN address each time, or may select the correlation CCF based on some other session-specific information available to all of the CCFs.

Although specific embodiments were described herein, the scope of the invention is not limited to those specific embodiments. The scope of the invention is defined by the following claims and any equivalents thereof.

We claim:

1. A charging system operable to correlate charging records from different network domains, the charging system comprising:
a plurality of charging functions connected to at least one of an IP Multimedia Subsystem (IMS) domain and a packet bearer domain;
a first one of the charging functions is operable to receive accounting messages from the IMS domain, to generate charging records for the IMS domain based on the accounting messages, to identify the charging records for a particular session in the IMS domain based on a charging identifier assigned in the IMS domain to the session, to select one of the plurality of charging functions on a per-session basis as a correlation charging function for the session, and to forward the identified charging records for the session in the IMS domain to the correlation charging function; and
a second one of the charging functions is operable to receive accounting messages for the session from the packet bearer domain, to generate a charging record for the packet bearer domain based on the accounting messages, to select the one of the plurality of charging functions on a per-session basis as the correlation charging function for the session, and to forward the charging record for the session in the packet bearer domain to the correlation charging function.

2. The charging system of claim 1 wherein:
the correlation charging function is operable to correlate the charging records for the IMS domain and the charging record for the packet bearer domain to generate a consolidated Charging Data Record (CDR) for the session, and to forward the consolidated CDR to a billing system.

3. The charging system of claim 2 wherein:
the correlation charging function is further operable to receive a charging record for a Serving-Call Session Control Function (S-CSCF) in the IMS domain, to identify the charging identifier assigned in the IMS domain in the charging record for the S-CSCF, to identify the charging records for the IMS domain that include the charging identifier assigned in the IMS domain, to identify at least one charging identifier assigned to the session in the packet bearer domain that is included in the charging record for the S-CSCF, to identify the charging records for the packet bearer domain that include the at least one charging identifier assigned in the packet bearer domain, and to correlate the identified charging records based on the charging identifiers to generate the consolidated CDR.

4. The charging system of claim 2 wherein:
the packet bearer domain comprises a General Packet Radio Service (GPRS) domain.

5. The charging system of claim 4 wherein:
the first charging system and the second charging system are operable to identify an Access Network Charging Identifier (ANCID) assigned to the session in GPRS domain, and to select the correlation charging function based on the ANCID and a distributing function that distributes the correlation charging function among the plurality of charging functions on a per-session basis.

6. The charging system of claim 5 wherein:
the distributing function comprises a modulo function; and
the first charging system and the second charging system are operable to use the modulo function with at least a portion of the ANCID as the dividend in the modulo function.

7. The charging system of claim 4 wherein:
the first charging system and the second charging system are operable to identify an address for a Gateway GPRS Support Node (GGSN) that serves the session in the GPRS domain, and to select the correlation charging function based on the GGSN address and a distributing function that distributes the correlation charging function among the plurality of charging functions on a per-session basis.

8. The charging system of claim 7 wherein:
the distributing function comprises a modulo function; and
the first charging system and the second charging system are operable to use the modulo function with at least a portion of the GGSN address as the dividend in the modulo function.

9. A method of correlating charging records from different network domains in a charging system comprised of a plurality of charging functions, the method comprising:
receiving accounting messages from an IP Multimedia Subsystem (IMS) domain;
generating charging records for the IMS domain based on the accounting messages;
identifying the charging records for a particular session in the IMS domain based on a charging identifier assigned in the IMS domain to the session;
selecting one of the plurality of charging functions on a per-session basis as a correlation charging function for the session;
forwarding the identified charging records for the session in the IMS domain to the correlation charging function;
receiving accounting messages for the session from a packet bearer domain;
generating a charging record for the packet bearer domain based on the accounting messages;
selecting the one of the plurality of charging functions on a per-session basis as the correlation charging function for the session; and
forwarding the charging record for the session in the packet bearer domain to the correlation charging function.

10. The method of claim 9 further comprising:
correlating the charging records for the IMS domain and the charging record for the packet bearer domain to generate a consolidated Charging Data Record (CDR) for the session; and
forwarding the consolidated CDR to a billing system.

11. The method of claim 10 wherein correlating the charging records comprises:
receiving a charging record for a Serving-Call Session Control Function (S-CSCF) in the IMS domain;
identifying the charging identifier assigned in the IMS domain in the charging record for the S-CSCF;
identifying the charging records for the IMS domain that include the charging identifier assigned in the IMS domain;
identifying at least one charging identifier assigned to the session in the packet bearer domain that is included in the charging record for the S-CSCF;
identifying the charging records for the packet bearer domain that include the at least one charging identifier assigned in the packet bearer domain; and
correlating the identified charging records based on the charging identifiers to generate the consolidated CDR.

12. The method of claim 10 wherein:
the packet bearer domain comprises a General Packet Radio Service (GPRS) domain.

13. The method of claim 12 wherein selecting one of the plurality of charging functions on a per-session basis comprises:
identifying an Access Network Charging Identifier (ANCID) assigned to the session in GPRS domain; and
selecting the correlation charging function based on the ANCID and a distributing function that distributes the correlation charging function among the plurality of charging functions on a per-session basis.

14. The method of claim 13 wherein:
the distributing function comprises a modulo function; and
selecting the correlation charging function comprises using the modulo function with at least a portion of the ANCID as the dividend in the modulo function.

15. The method of claim 12 wherein selecting one of the plurality of charging functions on a per-session basis comprises:
identifying an address for a Gateway GPRS Support Node (GGSN) that serves the session in the GPRS domain; and
selecting the correlation charging function based on the GGSN address and a distributing function that distributes the correlation charging function among the plurality of charging functions on a per-session basis.

16. The method of claim 15 wherein:
the distributing function comprises a modulo function; and
selecting the correlation charging function comprises using the modulo function with at least a portion of the GGSN address as the dividend in the modulo function.

17. A communication network, comprising:
an IP Multimedia Subsystem (IMS) domain;
a General Packet Radio Service (GPRS) domain; and
a charging system connected to the IMS domain and the GPRS domain, and comprised of a plurality of charging functions;
a first one of the charging functions is operable to generate charging records for the IMS domain based on accounting messages, to filter the charging records in the IMS domain based on a charging identifier assigned in the IMS domain to a particular session, to select a correlation charging function from the plurality of charging functions for the session based on a distributing function that distributes duties of correlation on a per-session basis among the plurality of charging functions, and to forward the identified charging records for the session in the IMS domain to the correlation charging function; and
a second one of the charging functions is operable to generate charging records for the packet bearer domain based on accounting messages, to select the correlation charging function from the plurality of charging functions for the session based on the distributing function, and to forward the charging records for the session in the packet bearer domain to the correlation charging function.

18. The communication network of claim 17 wherein:
the correlation charging function is operable to correlate the charging records for the IMS domain and the charging records for the packet bearer domain to generate a consolidated Charging Data Record (CDR) for the session, and to forward the consolidated CDR to a billing system.

19. The communication network of claim 17 wherein:
the first charging system and the second charging system are operable to identify an Access Network Charging Identifier (ANCID) assigned to the session in GPRS domain, and to select the correlation charging function based on the distributing function and the ANCID.

20. The communication network of claim 17 wherein:
the first charging system and the second charging system are operable to identify an address for a Gateway GPRS Support Node (GGSN) that serves the session in the GPRS domain, and to select the correlation charging function based on the distributing function and the GGSN address.
